(19) United States
(12) Patent Application Publication
(10) Pub. No.: US 2025/0191108 A1
(43) Pub. Date: Jun. 12, 2025

(54) METHOD AND DEVICE FOR REMOTELY ACCESSING GRAPHICS PROCESSING UNITS

(71) Applicant: Lenovo (Beijing) Limited, Beijing (CN)

(72) Inventors: Chengchun LIU, Beijing (CN); Yonggong WANG, Beijing (CN); Yan LI, Beijing (CN); Chao JIANG, Beijing (CN)

(21) Appl. No.: 18/912,553

(22) Filed: Oct. 10, 2024

(30) Foreign Application Priority Data
Dec. 7, 2023 (CN) 202311674664.1

(51) Int. Cl. G06T 1/20

(52) U.S. Cl. CPC G06T 1/20

(57) ABSTRACT

A method applied to a first node including a first processor and a virtual machine includes the virtual machine generating target information including an application request and satisfying a preset transmission information rule for transmission between a virtual graphics processing unit driver module of the virtual machine and the first processor, and the first processor determining, based on the target information, a target service module at a second node and connected to a target graphics processing unit and a transmission path connecting the virtual graphics processing unit driver, the first processor, a second processor at the second node, and the target service module, sending the application request to the target service module based on the transmission path, and receiving a processing result fed back by the second processor through the transmission path.

### CROSS-REFERENCE TO RELATED APPLICATION

This application claims priority to Chinese Patent Application No. 202311674664.1, filed on Dec. 7, 2023, the entire content of which is incorporated herein by reference.

### TECHNICAL FIELD

The present disclosure generally relates to the field of information processing technologies and, more particularly, to a method and a device for remotely accessing graphics processing units.

### BACKGROUND

As one of the most important heterogeneous processors, graphics processing unit (GPU) is widely used in artificial intelligence (AI), image rendering, high performance computing (HPC) and other fields. GPU remote virtualization technology further expands the application scope of the GPU, allowing applications on machines without a GPU to use the computing power of the GPU. This technology virtualizes GPU devices on an operating system, transmits computing requests to remote physical GPUs through the network, and returns the results after the calculation is completed. In this process, data needs to be copied multiple times and passed through multiple layers of network protocol stacks before being transmitted to the machine where the remote GPUs are located through the network.

For cloud computing scenarios, data usually needs to be processed and forwarded through virtual machine manager (VMM) layers, and the processing and forwarding of the VMM software layers requires input/output (I/O) operations. These cumbersome and inefficient I/O operations increase the communication delay of GPU remote access, resulting in more GPU clock cycles being wasted on I/O operations, thereby reducing the overall computing throughput of GPU tasks.

### SUMMARY

In accordance with the present disclosure, there is provided a method applied to a first node including a first processor and a virtual machine. The method includes the virtual machine generating target information including an application request and satisfying a preset transmission information rule for transmission between a virtual graphics processing unit driver module of the virtual machine and the first processor, and the first processor determining, based on the target information, a target service module at a second node and connected to a target graphics processing unit and a transmission path connecting the virtual graphics processing unit driver, the first processor, a second processor at the second node, and the target service module, sending the application request to the target service module based on the transmission path, and receiving a processing result fed back by the second processor through the transmission path.

Also in accordance with the present disclosure, there is provided a method including receiving an application request transmitted by a first processor at a first node, by a second processor at a second node, sending, by the second processor, the application request to a target service module at the second node and connected to a target graphics processing unit, calling, by the target service module, the target graphics processing unit based on the application request, responding, by the target graphics processing unit, to the application request to obtain a processing result, feeding, by the target graphics processing unit, back the processing result to the second processor, and sending, by the second processor, the processing result to the first processor.

Also in accordance with the present disclosure, there is provided a device applied at a first node and including one or more memories storing one or more programs, and one or more processors including a first processor and configured to execute the one or more programs to generate target information including an application request and satisfying a preset transmission information rule for transmission between a virtual graphics processing unit driver module of a virtual machine at the first node and the first processor, determine, based on the target information, a target service module at a second node and a transmission path, the target service module being connected to a target graphics processing unit, and the transmission path connecting the virtual graphics processing unit driver, the first processor, a second processor at the second node, and the target service module, send the application request to the target service module based on the transmission path, and receive a processing result fed back by the second processor through the transmission path.

### BRIEF DESCRIPTION OF THE DRAWINGS

FIG. 1 is a flowchart of a method for remotely accessing graphics processing units consistent with the present disclosure.

FIG. 2 is a structural diagram of a system for remotely accessing graphics processing units consistent with the present disclosure.

FIG. 3 is another flowchart of a method for remotely accessing graphics processing units consistent with the present disclosure.

FIG. 4 is a diagram showing a functional structure of a virtual machine used in a method for remotely accessing graphics processing units consistent with the present disclosure.

FIG. 5 is another flowchart of a method for remotely accessing graphics processing units consistent with the present disclosure.

FIG. 6 is a structural diagram of a relationship in a method for remotely accessing graphics processing units consistent with the present disclosure.

FIG. 7 is a structural diagram of a first processor consistent with the present disclosure.

FIG. 8 is another flowchart of a method for remotely accessing graphics processing units consistent with the present disclosure.

FIG. 9 is another flowchart of a method for remotely accessing graphics processing units consistent with the present disclosure.

FIG. 10 is another flowchart of a method for remotely accessing graphics processing units consistent with the present disclosure.

FIG. 11 is a schematic diagram of an application system of a method for remotely accessing graphics processing units consistent with the present disclosure.

FIG. 12 is a structural diagram of a device for remotely accessing graphics processing units consistent with the present disclosure.

FIG. 13 is another structural diagram of a device for remotely accessing graphics processing units consistent with the present disclosure.

### DETAILED DESCRIPTION OF THE EMBODIMENTS

Specific embodiments of the present disclosure are hereinafter described with reference to the accompanying drawings. The described embodiments are merely examples of the present disclosure, which may be implemented in various ways. Specific structural and functional details described herein are not intended to limit, but merely serve as a basis for the claims and a representative basis for teaching one skilled in the art to variously employ the present disclosure in substantially any suitable detailed structure. Various modifications may be made to the embodiments of the present disclosure. Thus, the described embodiments should not be regarded as limiting, but are merely examples. Those skilled in the art will envision other modifications within the scope and spirit of the present disclosure.

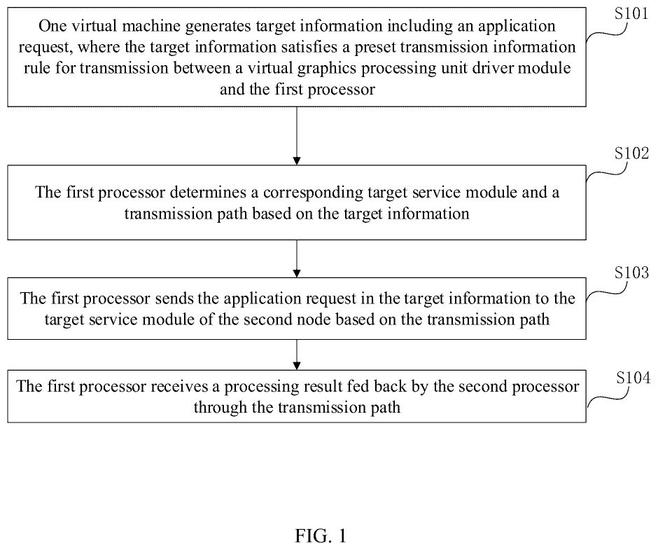

The present disclosure provides a method for remotely accessing graphics processing units. The method may be applied to an electronic device, and the electronic device may be a first node on which a first processor and at least one virtual machine are deployed. In one embodiment shown in FIG. 1, the method includes S101 to S104.

At S101, one virtual machine generates target information including an application request, and the target information satisfies a preset information transmission rule for transmission between a virtual graphics processing unit driver module and the first processor.

One or more virtual machines may be deployed on the first node, and each virtual machine may run a compute unified device architecture (CUDA, a parallel computing platform and programming model) application.

In one embodiment, one CUDA application may run on one virtual machine, and the CUDA application may access the virtual graphics processing unit driver module layer by layer via the CUDA runtime application program interface (API) and the driver API.

The first processor may be a data processing unit (DPU), which is a processor chip set on the first node. Correspondingly, the second processor may be a DPU processor chip set on the second node. The setting of two DPUs may offload the complex network protocol stack processing process to the hardware level.

Graphics processing units may not be deployed on the first node, and the virtual machine (VM) on the first node may remotely access graphics processing units on the second node, such that the graphics processing units perform data processing.

The preset information transmission rule may be a rule to ensure transparent transmission between the virtual graphics processing unit driver module and the first processor.

The application on the virtual machine may generate one application request, and the virtual machine may generate target information according to the application request.

In one embodiment, the application request may be an input-output (IO) request, which may be used to request the graphics processing unit to perform data processing.

The preset information transmission rule may be a set of communication primitives, and the specific implementation of the primitives may include achieving direct access from the virtual machine to the DPU device through SR-IOV (single root input/output virtualization) technology.

The target information may have a format different from the format of the application request. The application request may be converted into the target information of the primitives to enable the virtual machine to transmit the application request to the first processor through the target information.

The primitives may include an identification field and a request field, where the identification field is used to identify the virtual graphics processing unit driver module that generates the application request and the request field includes the application request, etc.

It should be noted that the process of generating the target information for the virtual machine is described in detail in the subsequent embodiments, which is not described in detail in this embodiment.

At S102, the first processor determines a corresponding target service module and a transmission path based on the target information. The target service module may be located at the second node. The target service module may be correspondingly connected to a target graphics processing unit. The transmission path may be a path connecting the virtual graphics processing unit driver module in the virtual machine through the first processor, the second processor in the second node, and the target service module.

The target information may carry an identifier of the virtual graphics processing unit that generates the target information.

A mapping table may be preset in the first processor, and the mapping table may record a correspondence between each virtual graphics processing unit and each remote graphics processing unit. Graphics processing units in the second node and the service modules may be set one-to-one.

After obtaining the target information, the first processor may analyze the target information to obtain the virtual graphics processing unit driver module that generates the application request in the target information, query the remote graphics processing unit corresponding to the virtual graphics processing unit driver module in the mapping table where the remote graphics processing unit corresponds to the service module one-to-one, and determine the transmission path. The transmission path may be the path connecting to the virtual graphics processing unit driver module in the virtual machine, the first processor, the second processor in the second node, and the target service module. The target service module may be connected to the only graphics processing unit, and the transmission path may be the path connecting the virtual graphics processing unit with the target graphics processing unit.

The second processor in the second node may be connected to the first processor in the first node through an interface, which realizes direct communication between the first processor and the second processor in the two nodes, ensuring that data is able to be directly transmitted between the two nodes without the need for group processing and forwarding through the VMM layer.

The second node may be provided with a host operating system (Host OS). Corresponding to the system on the virtual machine, the service module may be a functional module in the Host OS, which is set one-to-one with each graphics processing unit in the second node.

The service modules and the graphics processing units in the second node may be set one-to-one. The first processor may determine the corresponding target graphics processing unit in the second node based on the target information and the preset mapping table. Since the second node is connected to multiple service modules connected by the second processor to realize the connection of the graphics processing units respectively, the target service module corresponding to the target information may be determined, such that the first processor sends the application request in the target information to the second node through the second processor and the target service module.

In subsequent embodiments, the process of the first processor determining the corresponding target service module and the transmission path based on the target information is described in detail, which is not described in detail in this embodiment.

At S103, the first processor sends the application request in the target information to the target service module of the second node based on the transmission path.

After determining the transmission path and the target service module, the first processor may send the application request in the target information to the second processor of the second node, and the second processor of the second node may send the application request to the corresponding target service module after receiving the application request.

In one embodiment, the first processor may send the request field in the target information to the second node.

After receiving the application request, the target service module may call the corresponding GPU such that the GPU performs calculations to obtain processing results. After obtaining the processing results, the GPU may send the processing results to the second processor, and the second processor may feed back the processing results to the first processor through the interface.

The processing process at the second node will be described in detail in subsequent embodiments, and is not described in detail in this embodiment.

At S104, the first processor receives the processing results fed back by the second processor through the transmission path.

After receiving the processing results of the GPU, the second processor feeds back the processing results to the first processor through the interface connected to the first processor.

Accordingly, the first processor may receive the processing results.

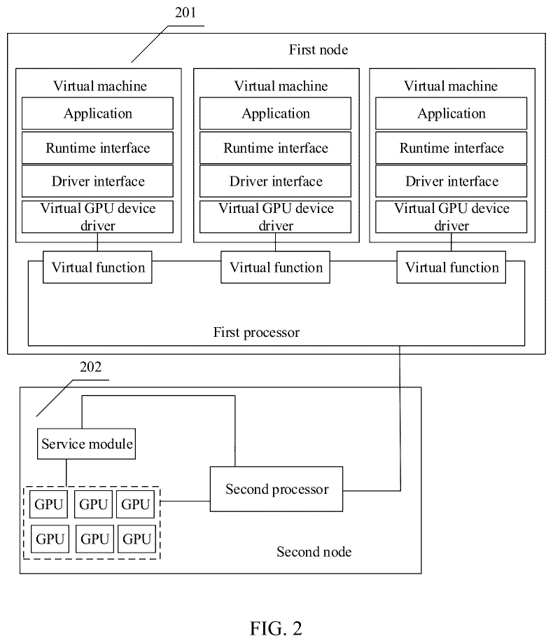

FIG. 2 shows a schematic diagram of a structure of a system for remotely accessing graphics processing units. The system includes a first node 201 and a second node 202. The first node may be used as an application node, on which a virtual machine and a first processor DPU are arranged. The second node may be used as a resource node, on which multiple GPUs and a second processor DPU are arranged. Each GPU may be provided with a corresponding service module, and the GPUs may serve as remote access resources of the first node. The first processor and the second processor may be respectively provided with interfaces, and data information may be transmitted between the two through the interfaces. Each virtual machine on the first node may include an application, a runtime interface, a driver interface, and a virtual GPU device driver. The first processor may be provided with a virtual function for each virtual machine, which is used to receive the target information sent by the virtual machine. The first processor may determine the corresponding target service module and transmission path according to the target information, and extract the application request in the target information. The first processor may send the application request to the second processor through the interface, and the second processor may send the application request to the target service module. The target service module may call its corresponding graphics processing unit GPU according to the application request. The corresponding graphics processing unit may respond to the application request to obtain the processing results, and feed the processing results back to the second processor. The second processor may send the processing results to the first processor through the interface.

In the method for remotely accessing the graphics processing units provided by the present disclosure, the method may be applied to the first node where the virtual machine and the first processor are deployed. The method may include that: the virtual machine generates target information containing the application request, where the target information satisfies the preset transmission rule between the virtual graphics processing unit driver module and the first processor; and, the virtual machine transmits the target information to the first processor; the first processor determines the corresponding transmission path and the corresponding target service module in the second node based on the target information, and transmits the application request in the target information to the corresponding target service module through the second processor of the second node based on the corresponding transmission path, and receive the processing results fed back by the second processor through the transmission path. Therefore, protocol processing acceleration may be achieved through a hardware DPU, offloading a complex network protocol stack processing process to the hardware level, and thereby significantly shortening the processing delay of data at these levels. Compared with the software protocol stack inside the VM, the DPU may have more powerful performance and may therefore provide lower latency.

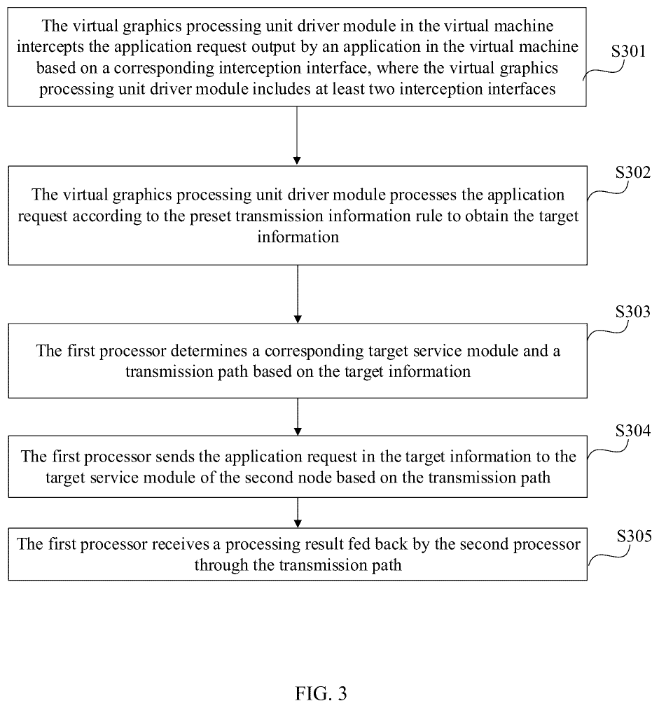

In another embodiment shown in FIG. 3, which is another flowchart of the method for remotely accessing the graphics processing units consistent with the present disclosure, the method may include S301 to S305.

At S301, the virtual graphics processing unit driver module in the virtual machine intercepts the application request output by the application in the virtual machine based on an interception interface.

The virtual graphics processing unit driver module may include at least two interception interfaces.

During the creation and initialization of the virtual machine, the virtual graphics processing unit driver module may create several virtual graphics processing unit files (virtual GPU device files) according to the hardware resource configuration, and these files may follow the NVIDIA GPU Driver standard, and may provide several types of interception interfaces for the CUDA Driver API to intercept the application request output by the application in the virtual machine.

The virtual graphics processing unit driver module may include a plurality of interception interfaces, and each interception interface may intercept a corresponding application request.

The function list of various interfaces in the virtual graphics processing unit driver module is shown in Table 1 below.

TABLE 1

| Interface type | Interface function and method |
|---|---|
| File operation interface | open: Called when opening a device file to initialize the device |
| function | status. |
| | release: Called when the device file is closed to clean up the |
| | device status. |
| | read: Read data from the device file. |
| | write: Write data to the device file. |
| Control command interface | ioctl: Process device control commands, such as configuring |
| function | parameters and performing specific operations. |
| Memory allocation and | dma_alloc_coherent: Allocate a contiguous DMA-accessible |
| deallocation functions | memory region. |
| | dma_free_coherent: Frees a previously allocated DMA- |
| | accessible memory area. |
| Interrupt handling function | request_irq: Request to handle a hardware interrupt. |
| | free_irq: Release a previously requested interrupt. |
| Memory Mapping | mmap: When need to map device memory to user space, this |
| Functions | function is implemented. |

Table 1 shows five types of interface categories, but the interface categories are not limited thereto. In various embodiments, other interface types and interface functions may also be set.

At S302, the virtual graphics processing unit driver module processes the application request according to the preset transmission information rule to obtain the target information.

After the virtual graphics processing unit driver module intercepts and obtains the application request, it may encapsulate and process the application request to obtain the target information that meets the preset transmission information rule.

When the virtual graphics processing unit driver module encapsulates and processes the application request, the identifier of the virtual graphics processing unit driver module may be added such that the first processor is able to determine which virtual graphics processing unit driver module in the first node sends the target information based on the identifier.

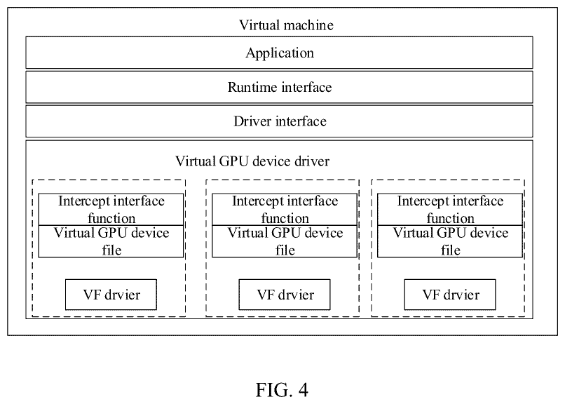

As shown in FIG. 4, which is a schematic diagram showing the functional structure of a virtual machine including the application, the runtime interface, the driver interface and the virtual GPU driver module, the plurality of interception interface functions may be set in the virtual GPU driver module, and each interception interface function may correspond to a virtual GPU device file and a VF (visual foxpro, a database software) driver. The application request intercepted by the interception interface function maybe encapsulated by the VF driver to obtain the target information and may be sent to the DPU.

It should be noted that, in this embodiment, a kernel-state virtual GPU device driver may be used for interception, which allows users to install and use different versions of CUDA more flexibly without being limited to a specific version, thereby increasing the scope of application of this method.

At S303, the first processor determines the corresponding target service module and the transmission path based on the target information. The target service module is located at the second node. The target service module is connected to the target graphics processing unit. The transmission path is the path through which the virtual graphics processing unit driver module in the virtual machine is connected through the first processor, the second processor in the second node, and the target service module.

At S304, the first processor sends the application request in the target information to the target service module of the second node based on the transmission path.

At S305, the first processor receives the processing results fed back by the second processor through the transmission path.

S303 to S305 may be consistent with the corresponding operations in the previous embodiments and are not repeated in this embodiment.

In the method for remotely accessing the graphics processing units provided by the present disclosure, the virtual graphics processing unit driver module in the virtual machine may include the plurality of interception interfaces, and each interception interface may correspond to one application request. The virtual graphics processing unit driver module may intercept the application request output by the application in the virtual machine based on the interception interface. The virtual graphics processing unit driver module may process the application request according to the preset transmission information rule to obtain the target information, thereby realizing the interception of the application request generated by the application in the virtual machine and processing it into the target information that is able to be sent to the first processor.

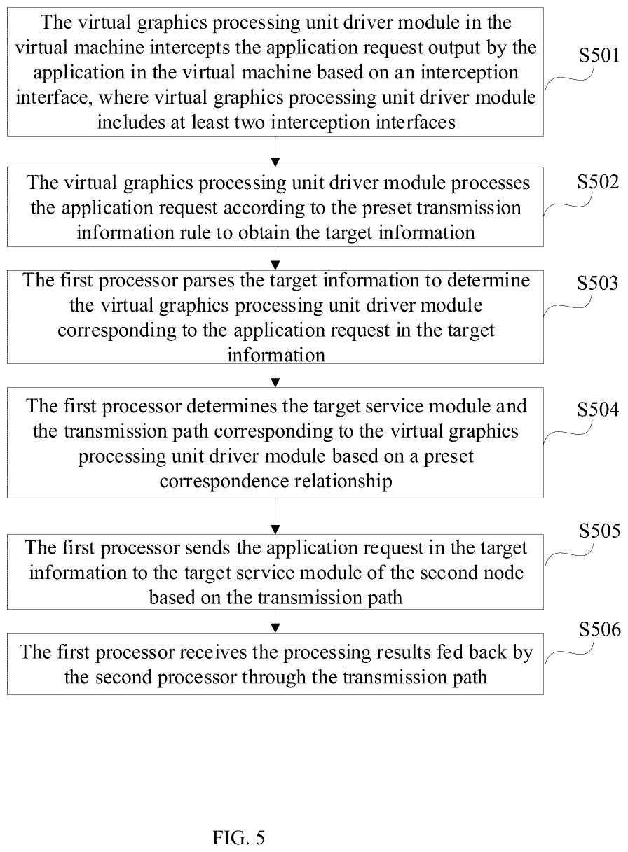

In another embodiment shown in FIG. 5, another flowchart of the method for remotely accessing the graphics processing units consistent with the present disclosure, the method may include S501 to S506.

At S501, the virtual graphics processing unit driver module in the virtual machine intercepts the application request output by the application in the virtual machine based on an interception interface. The virtual graphics processing unit driver module may include at least two interception interfaces.

At S502, the virtual graphics processing unit driver module processes the application request according to the preset transmission information rule to obtain the target information.

S501 to S502 may be consistent with the corresponding steps in the previous embodiments and are not repeated in this embodiment.

At S503, the first processor parses the target information to determine the virtual graphics processing unit driver module corresponding to the application request in the target information.

After receiving the target information, the first processor may parse the target information to obtain the virtual graphics processing unit driver module identifier carried therein, and determine that the application request of the target information is generated by the virtual graphics processing unit driver module corresponding to the identifier.

The first processor may be capable of parsing the target information of the virtual graphics processing unit driver modules of multiple virtual machines in the first node.

At S504, the first processor determines the target service module and the transmission path corresponding to the virtual graphics processing unit driver module based on a preset correspondence relationship. The transmission path may connect the second transmission module of the second processor and the first transmission module of the first processor. The first transmission module and the second transmission module may be transmission modules of the same type.

The first processor may be provided with a client module (CUDA RPC client) and a transmission module. The client module may be used to execute the aforementioned action of parsing the target information to obtain the corresponding virtual graphics processing unit driver module, and the action of sending the application request may be executed by the transmission module.

The two DPUs used for transmitting information may be respectively provided with transmission modules, and the same type of transmission modules may be selected in the two DPUs respectively to realize information transmission in the two nodes.

The first processor and the second processor are respectively provided with two transmission modules, and different transmission modules may adopt different network protocols. One transmission module may adopt TOE (TCP/IP Offload Engine), and the other transmission module may adopt RDMA (Remote Direct Memory Access).

The transmission path may include the adopted transmission modules, where the first processor adopts the TOE transmission module, and correspondingly, the second processor also adopts the TOE transmission module. The first processor and the second processor may adopt the TOE technology for transmission.

There may be a correspondence relationship in the client module of the first processor, and, according to the virtual graphics processing unit driver module, the corresponding target service module and the transmission path may be determined.

For example, in one embodiment, the CUDA RPC client may serve as a hardware acceleration module, which processes the communication primitives sent by all virtual machines VM on the first node inside the DPU and maintains a bidirectional mapping table for representing the correspondence relationship. The bidirectional mapping table may record the relationship between different virtual processor devices in different virtual machines and the remote physical graphics processing unit devices.

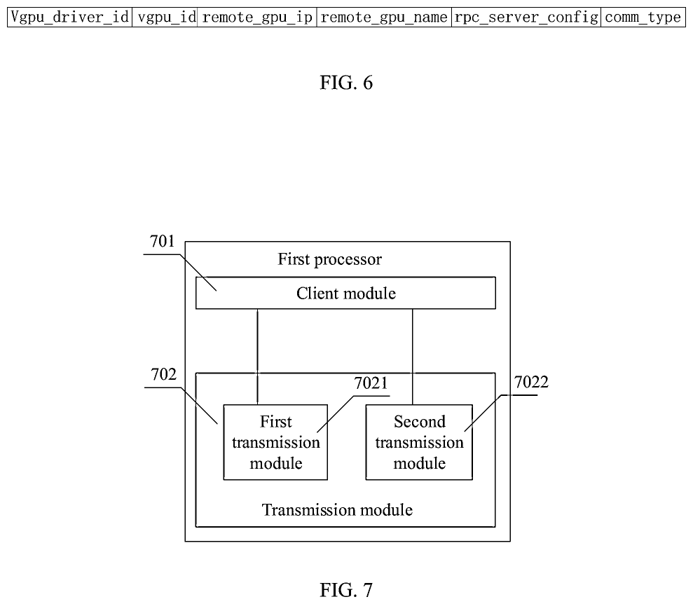

In one embodiment shown in the structure diagram of the correspondence relationship table in FIG. 6, the table may include 6 fields, namely vgpu_driver_id, vgpu_id, remote_gpu_ip, remote_gpu_name, rpc_server_config, and comm_type.

In the table, vgpu_driver_id and vgpu_id may be used to identify the virtual GPU device that sends the primitive, remote_gpu_ip and remote_gpu_name may be used to identify the remote physical GPU device corresponding to the virtual GPU device in the VM, comm_type may be used to identify the RPC link type, which is identified when the link is created, and rpc_server_config may be used to identify the RPC server (service module) in the second node.

The target information sent by the virtual graphics processing unit driver module may be a primitive, and vgpu_driver_id and vgpu_id may carry the identifier of the virtual graphics processing unit driver module. According to the field identifier, the corresponding remote_gpu_ip and remote_gpu_name fields and comm_type in the correspondence relationship table may be determined, to determine the corresponding remote physical GPU device and link type.

The link type may be which transmission module is used by the transmission path, and the application request may be subsequently sent to the corresponding transmission module in the second processor of the second node based on the transmission path.

As shown in FIG. 7, which is a structural schematic diagram of the first processor, the first processor may include a client module 701 and a transmission module 702. The transmission module may include a first transmission module 7021 and a second transmission module 7022. The client module may be used as a hardware acceleration module, for processing the target information received in the form of primitives to obtain the identifier of the corresponding virtual graphics processing unit driver module. Based on the identifier and the correspondence relationship maintained by the client module, the corresponding remote physical GPU device and link type may be determined, and the corresponding transmission module may be selected to output the application request.

It should be noted that the first processor subsequently may receive the processing results fed back by the second processor of the second node, and the transmission between the first processor and the second processor may be realized through the same transmission module.

It should be noted that the process of determining the remote physical GPU may involve processing of the network protocol stack. In this embodiment, because the network protocol stack processing is completed on the DPU hardware, which will not occupy the computing resources of the virtual machine, the user may be allowed to make full use of the computing resources applied for by the virtual machine without being affected by the network protocol stack processing.

At S505, the first processor sends the application request in the target information to the target service module of the second node based on the transmission path.

At S506, the first processor receives the processing results fed back by the second processor through the transmission path.

S505 and S506 may be consistent with the corresponding steps in previous embodiments, and are not repeated in this embodiment.

In the method for remotely accessing the graphics processing units provided in this embodiment, the first processor may parse the received target information, determine the virtual graphics processing unit driver module corresponding to the application request in the target information, and determine the target service module and transmission path corresponding to the virtual graphics processing unit driver module based on the preset correspondence relationship. The transmission path may connect through the first transmission module of the first processor and the second transmission module of the second processor. The first transmission module and the second transmission module may be transmission modules of the same type. Information transmission between the first processor and the second processor may be achieved, offloading the complex network protocol station processing to the acceleration protocol processing module of the DPU hardware. Therefore, the number of IO times of remote access may be reduced, compressing the processing delay of network protocol processing and improving the response speed.

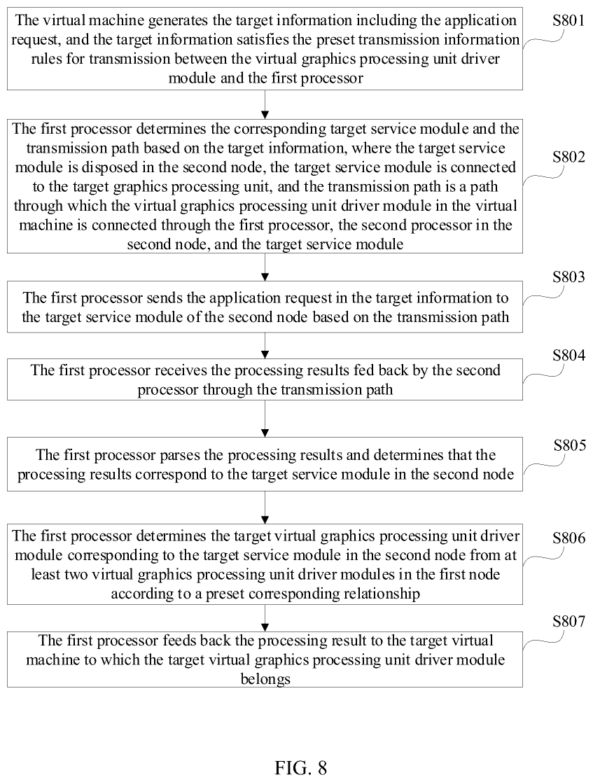

In another embodiment shown in FIG. 8, which is another flowchart of the method for remotely accessing the graphics processing units consistent with the present disclosure, the method may include S801 to S807.

At S801, the virtual machine generates the target information including the application request, and the target information satisfies the preset transmission information rules for transmission between the virtual graphics processing unit driver module and the first processor.

At S802, the first processor determines the corresponding target service module and the transmission path based on the target information. The target service module may be disposed at the second node, and the target service module may be connected to the target graphics processing unit. The transmission path may be the path through which the virtual graphics processing unit driver module in the virtual machine is connected through the first processor, the second processor in the second node, and the target service module.

At S803, the first processor sends the application request in the target information to the target service module of the second node based on the transmission path.

At S804, the first processor receives the processing results fed back by the second processor through the transmission path.

S801 to S804 may be consistent with the corresponding steps in previous embodiments, and are not repeated in this embodiment.

At S805, the first processor parses the processing results and determines that the processing results correspond to the target service module in the second node.

The remote physical GPU in the second processor may respond to the application request, and, after obtaining the processing results, the processing result may be fed back to the first processor.

After receiving the processing results, the first processor may determine which service module in the second node the processing result corresponds to, where the service module corresponds to the graphics processing unit.

For example, in one embodiment, the first processor may parse the processing result to obtain the IP (Internet Protocol) and RPC server identification information of the data source, where the IP is the IP of the second node and the RPC sever is the service module in the second node.

At S806, the first processor determines the target virtual graphics processing unit driver module corresponding to the target service module in the second node from at least two virtual graphics processing unit driver modules (candidate virtual graphics processing unit driver modules) in the first node according to a preset correspondence relationship.

The preset correspondence relationship may be provided in the first processor, and the mapping table structure represented by the correspondence relationship is shown in FIG. 6.

The first processor may search for the corresponding target virtual processor virtual module in the preset correspondence relationship according to the second node obtained by parsing and the service module identification therein.

For example, in one embodiment, the vgpu_driver_id and vgpu_id information may be determined based on the remote_gpu_ip and rpc_server_config fields in the mapping table, where the vgpu_driver_id and vgpu_id are the identifiers of the virtual graphics processing unit driver module.

At S807, the first processor feeds back the processing result to the target virtual machine to which the target virtual graphics processing unit driver module belongs.

The first processor may feed back the processing results to the target virtual machine to which the target virtual graphics processing unit driver module belongs, thereby realizing the feedback of the remote GPU processing results to the virtual machine.

In the method for remotely accessing the graphics processing units provided by the present disclosure, the first processor may parse the processing results, determine the target service module in the second node corresponding to the processing results, determine the target virtual graphics processing unit driver module corresponding to the target service module in the second node from at least two virtual graphics processing unit driver modules in the first node according to the preset correspondence relationship, and feed back the processing results to the target virtual machine to which the target virtual graphics processing unit driver module belongs. By determining the corresponding target virtual graphics processing unit driver module through the preset correspondence relationship and then feeding back the processing results received from the second processor of the second node to the target virtual machine to which the target virtual graphics processing unit driver module belongs, the process of feeding back the processing results of the remote GPU to the virtual machine may be realized, improving the speed of data in the protocol processing process and shortening the processing time.

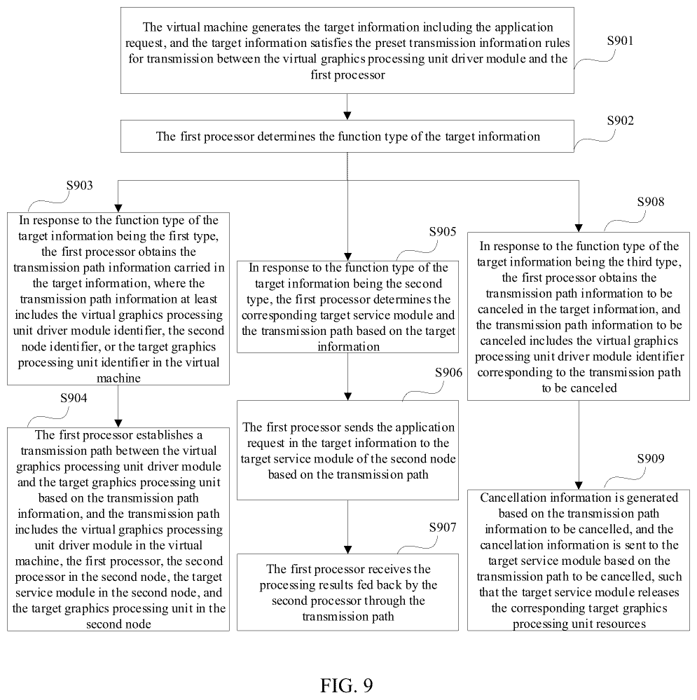

In another embodiment shown in FIG. 9, which is another flowchart of the method for remotely accessing the graphics processing units consistent with the present disclosure, the method may include S901 to S909.

At S901, the virtual machine generates the target information including the application request, and the target information satisfies the preset transmission information rules for transmission between the virtual graphics processing unit driver module and the first processor.

S901 may be consistent with the corresponding steps in previous embodiments, and are not repeated in this embodiment.

At S902, the first processor determines the function type of the target information.

When the function type of the target information is the first type, 903 to S904 may be executed. When the function type is the second type, S905 to S907 may be executed. When the function type is the third type, S908 to S909 may be executed.

The communication primitives between the virtual graphics processing unit driver module and the first processor may be able to describe a variety of specific communication behaviors, such as initializing the entire remote PGU service, forwarding the request to the service module of the second node, deregistering the virtual GPU device, etc.

For example, some communication behaviors described by the communication primitives are shown in Table 2 below.

TABLE 2

| Name | Function | Parameters |
|---|---|---|
| Init_Remote_GPU | Register the | vgpu_driver_id: The identifier of the virtual |
| | virtual GPU | GPU device driver. |
| | information | vgpu_id: The identifier of the virtual GPU |
| | with the RPC | device. |
| | client, establish | remote_gpu_ip: The IP address of the machine |
| | a communication | where the RPC_server is located. The remote |
| | link with the | GPU is also on this machine. |
| | remote physical | remote_gpu_name: The device name of the |
| | GPU, and | remote GPU on the node where it is located. |
| | complete the | comm_type: The communication protocol used |
| | initialization of | by the RPC communication link, supporting |
| | the entire | TOE and RDMA. |
| | remote GPU | rpc_server_config: The configuration of the |
| | service. | rpc_server service, which will vary depending |
| | | on the comm_type field. |
| Data _Send | Tells the RPC | vgpu_driver_id; The identifier of the virtual |
| | client to forward | GPU device driver. |
| | the request | vgpu_id; The identifier of the virtual GPU |
| | carried in the | device. |
| | primitive | request; Intercepted raw GPU device interface |
| | request directly | requests and their parameters. |
| | to the RPC | |
| | server. | |
| Uninit_Remote_GPU | Initiate a virtual | vgpu_driver_id; The identifier of the virtual |
| | GPU device | GPU device driver. |
| | deregistration | vgpu_id; The identifier of the virtual GPU |
| | request to the | device. |
| | RPC client. The | |
| | RPC client will | |
| | inform the RPC | |
| | server to release | |
| | the physical | |
| | GPU resources. | |

The client module (CUDA RPC client) of the first processor may parse the target information to obtain the parameters contained therein, and the function type of the target information may be determined according to the parameters contained therein.

As an example, in one embodiment, when the received target information includes vgpu_driver_id, vgpu_id, remote_gpu_ip, remote_gpu_name and comm_type, it may be determined that the received target information is Init_Remote_GPU and the function type is the first type.

For example, when the received target information includes vgpu_driver_id, vgpu_id and request, it may be determined that the received target information is Data_Send primitive and the function type is the second type.

For example, when the received target information only includes vgpu_driver_id and vgpu_id, it may be determined that the received target information is Uninit_Remote_GPU primitive and its function type is the third type.

At S903: in response to the function type of the target information being the first type, the first processor obtains the transmission path information carried in the target information, where the transmission path information at least includes the virtual graphics processing unit driver module identifier, the second node identifier, or the target graphics processing unit identifier in the virtual machine.

The first processor may parse the parameters contained in the target information to determine the function type of the target information.

When the function type is the first type, which is used to register the virtual GPU information with the RPC client, establish a communication link with the remote physical GPU, and complete the initialization of the entire remote GPU service, the first processor may obtain the transmission path information carried in the target information, and the transmission path information may be information related to the transmission path.

When the target information is of the first type, the target information may carry the virtual graphics processing unit driver module identifier (vgpu_driver_id), the virtual graphics processing unit identifier (vgpu_id), the second node identifier (remote_gpu_ip), and the target graphics processing unit identifier (remote_gpu_name).

At S904, the first processor establishes a transmission path between the virtual graphics processing unit driver module and the target graphics processing unit based on the transmission path information, and the transmission path includes the virtual graphics processing unit driver module in the virtual machine, the first processor, the second processor in the second node, the target service module in the second node, and the target graphics processing unit in the second node.

Based on the transmission path information, the transmission path between the virtual graphics processing unit driver module involved and the target graphics processing unit may be established.

The transmission path may be a path that sequentially connects the virtual graphics processing unit driver module in the virtual machine, the first processor, the second processor in the second node, the target service module in the second node, and the target graphics processing unit in the second node.

There may be two transmission modules in the first processor and the second processor. To ensure accurate transmission between the first processor and the second processor, the target information may also carry a link type identifier (comm_type), and the transmission modules selected by the first processor and the second processor may be determined based on the link type identifier, and the connection between the first processor and the second processor may be established based on the transmission module.

At S905, in response to the function type of the target information being the second type, the first processor determines the corresponding target service module and the transmission path based on the target information.

At S906, the first processor sends the application request in the target information to the target service module of the second node based on the transmission path.

At S907, the first processor receives the processing results fed back by the second processor through the transmission path.

S905 to S907 may be consistent with the corresponding steps in previous embodiments and are not repeated in this embodiment.

At S908, in response to the function type of the target information being the third type, the first processor obtains the transmission path information to be canceled in the target information, and the transmission path information to be canceled includes the virtual graphics processing unit driver module identifier corresponding to the transmission path to be canceled.

When the function type is the third type, it may be used to initiate a virtual GPU device cancellation request to the RPC client. Then, the first processor may obtain the transmission path information to be cancelled carried in the target information, and the transmission path information to be cancelled may be information related to the transmission path.

When the target information is the third type, it may only carry the virtual graphics processing unit driver module identifier (vgpu_driver_id) and the virtual graphics processing unit identifier (vgpu_id).

At S909, cancellation information is generated based on the transmission path information to be cancelled, and the cancellation information is sent to the target service module based on the transmission path to be cancelled, such that the target service module releases the corresponding target graphics processing unit resources.

Based on the virtual graphics processing unit driver module identifier (vgpu_driver_id) and the virtual graphics processing unit identifier (vgpu_id) in the transmission path information to be cancelled, it may be determined that the access to the virtual graphics processing unit driver module, the virtual graphics processing unit and the corresponding remote physical GPU is cancelled.

After obtaining the virtual graphics processing unit driver module identifier (vgpu_driver_id) and the virtual graphics processing unit identifier (vgpu_id) in the transmission path information to be cancelled, the first processor may determine the corresponding target service module based on the preset correspondence relationship.

According to the transmission path to be cancelled, the cancellation information may be generated, and the cancellation information may be sent to the target service module, such that the target service module releases the corresponding physical GPU resources according to the cancellation information.

After sending the cancellation information to the target service module, the first processor may close the connection with the target service module and delete the corresponding record from the mapping list of the correspondence relationship.

In the method for remotely accessing the graphics processing units provided by the present disclosure, after receiving the target information, the first processor may parse the target information to determine the function type to which it belongs. When the target information is of the first type, the transmission path between the virtual graphics processing unit driver module in the virtual machine in the first node and the target graphics processing unit in the second node may be established based on the information carried in the target information. When the target information is of the second type, the application request of the target information may be transmitted to the second node through the transmission path between the virtual graphics processing unit driver module and the target graphics processing unit in the second node, such that the target graphics processing unit of the second node responds to the application request and obtains the processing results. When the target information is of the third type, based on the information carried in the target information, the transmission path between the virtual graphics processing unit module and the target graphics processing unit may be canceled, such that the target service module releases the corresponding physical GPU resources. Therefore, based on the different specific communication behaviors described by the communication primitives, communication of different communication behaviors between the virtual graphics processing unit driver module and the first processor may be realized.

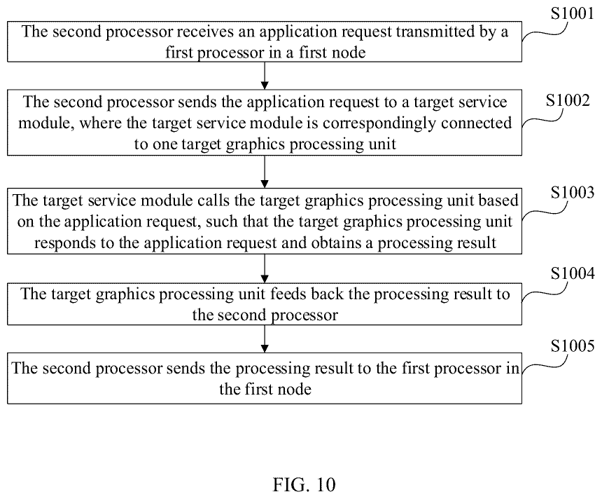

Corresponding to the above-mentioned embodiments of the method for remotely accessing the graphics processing units applied to the first node, the present disclosure also provides a method for remotely accessing the graphics processing units applied to the second node. As shown in FIG. 10, which is a flowchart of a method for remotely accessing the graphics processing units consistent with the present disclosure, in one embodiment, the method may be applied to an electronic device which serves as the second node on which a graphics processing unit set and a second processor are deployed. The method may include S1001 to S1005.

At S1001, the second processor receives the application request transmitted by the first processor in the first node.

The graphics processing unit set may be deployed on the second node, and the graphics processing unit set may include at least one graphics processing unit.

The at least one graphics processing unit on the second node may be accessed by the virtual machine on the first node in the form of remote access, and the at least one graphics processing unit may perform data processing in response to the remote access.

The second processor and the first processor may be respectively provided with interfaces, and the second processor and the first processor may transmit data through the interfaces.

At S1002, the second processor sends the application request to the target service module, where the target service module is connected to the target graphics processing unit.

After receiving the application request, the second processor may send the application request to the corresponding target service module.

The target service module may be set corresponding to the GPU.

It should be noted that for isolation and security reasons, the number of RPC servers in the second node may be consistent with the number of physical GPUs on the machine. Each RPC server may be responsible for responding to requests from one physical GPU. Since one RPC server only responds to requests sent by one RPC client at the same time and sends the request to the same GPU, the RPC server may not need to maintain a mapping table.

At S1003, the target service module calls the target graphics processing unit based on the application request such that the target graphics processing unit responds to the application request and obtains the processing results.

The target service module in the second node may call its corresponding target processor based on the application request.

The target graphics processing unit may respond to the application request, perform GPU calculation, and obtain the processing results.

The second node may be provided with a Host OS, and the Host OS may include the a service module (CUDA RPC server) and the graphics processing unit driver (NVDIA GPU Driver) interface.

In one embodiment, the service module GPU RPC Server may call the NVIDIA GPU Driver interface to call the physical GPU, perform real GPU calculations, and obtain the processing results.

At S1004, the target graphics processing unit feeds back the processing results to the second processor.

The graphics processing unit and the second processor may be connected in a Direct IO direct connection mode.

The graphics processing unit may feed back the processing results directly to the second processor through the Direct IO direct connection without passing through the service module.

At S1005, the second processor sends the processing results to the first processor in the first node.

The second processor may send the processing results received from the graphics processing unit to the first processor in the first node, thus completing a complete GPU remote access process.

In the method for remotely accessing graphics processing units provided by the present disclosure, the method may be applied to the second node. The second processor may receive the application request transmitted by the first processor in the first node, and send the application request to the target service module correspondingly connected to the target graphics processing unit. The target service module may call the target graphics processing unit based on the application request, such that the target graphics processing unit responds to the application request and obtains the processing results. The target graphics processing unit may feed back the processing results to the second processor in a direct connection manner. The second processor may send the processing results to the first processor in the first node. The protocol processing may be accelerated through the hardware DPU and the complex network protocol stack processing process may be offloaded to the hardware level, thereby significantly shortening the processing delay of data at these levels. Compared with the software protocol stack inside the VM, the DPU may have more powerful performance and therefore lower latency.

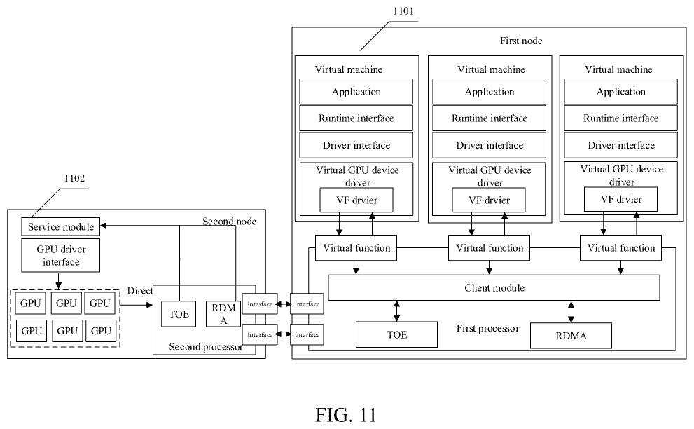

FIG. 11 is a schematic diagram of an application system of a method for remotely accessing graphics processing units. As shown in FIG. 11, in one embodiment, the system includes a first node 1101 and a second node 1102.

The first node may be used as an application node, on which a plurality of virtual machines and a first processor DPU are arranged. FIG. 11 uses three virtual machines for illustration, each of which includes an application, a runtime interface, a driver interface, and a virtual GPU device driver, and each virtual GPU device driver is provided with a VF driver. The first processor DPU may include a virtual function module, a client module (CUDA RPC client), a transmission module TOE, and a transmission module RDMA. Each virtual function module may transmit the received target information to the client module, and the client module may analyze and obtain the type of the target information and respond to the target information. When the target information is data_send information, the virtual GPU device driver identifier in the target information may be extracted, the corresponding remote GPU information and the RPC link type may be determined, and one of TOE or RDMA may be selected based on the RPC link type for transmission to the second node.

The second node may serve as a resource node, on which a plurality of GPUs and a second processor DPU are arranged. The Host OS on the second node may include service modules (CUDA RPC servers) and a graphics processing unit driver (NVDIA GPU Driver) interface. One service module may be arranged corresponding to each GPU. The service module may call the graphics processing unit driver interface to call the corresponding physical GPU. The GPU may send the processing result to the second processor through the Direct IO between the GPU and the second processor. Multiple interfaces may be arranged between the second processor and the first processor, such that multiple information may be transmitted simultaneously.

The present disclosure also provides an electronic device for application of a method for remotely accessing graphics processing units.

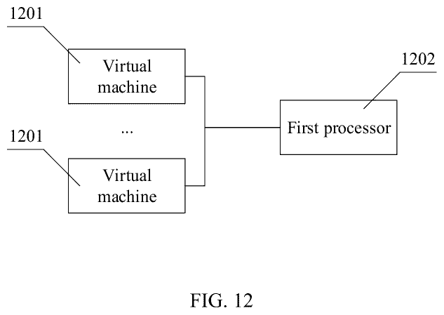

In one embodiment shown in FIG. 12, which is a structural schematic diagram of an electronic device for application of the method for remotely accessing graphics processing units, the electronic device may be applied to the first node, and may include at least one virtual machine 1201 and a first processor 1202.

The virtual machine 1201 may be used to generate the target information including the application request, where the target information satisfies the preset transmission information rule for transmission between the virtual graphics processing unit driver module and the first processor.

The first processor 1202 may be used to determine the corresponding target service module and the transmission path based on the target information. The target service module may be located at the second node, the target service module may be correspondingly connected to the target graphics processing unit, and the transmission path may be the path through which the virtual graphics processing unit driver module in the virtual machine may be connected through the first processor, the second processor in the second node, and the target service module. The first processor may send the application request in the target information to the target service module of the second node based on the transmission path. The first processor may receive the processing results fed back by the second processor through the transmission path.

Optionally, when the virtual machine generates the target information including the application request, the virtual graphics processing unit driver module in the virtual machine may intercept the application request output by the application in the virtual machine based on the interception interfaces, where the virtual graphics processing unit driver module may include at least two interception interfaces; and the virtual graphics processing unit driver module may process the application request according to the preset transmission information rules to obtain the target information.

Optionally, that the first processor determines the corresponding target service module and transmission path based on the target information, may include:
the first processor parses the target information to determine the virtual graphics processing unit driver module corresponding to the application request in the target information; and
the first processor determines the target service module and transmission path corresponding to the virtual graphics processing unit driver module based on the preset correspondence, and the transmission path may be connected to the second transmission module of the second processor through the first transmission module of the first processor, where the first transmission module and the second transmission module may be transmission modules of the same type.

Optionally, after the first processor receives the processing results fed back by the second processor through the transmission path, it may be also used to:
parse the processing results to determine whether the processing results correspond to the target service module in the second node;
determine the target virtual graphics processing unit driver module corresponding to the target service module in the second node from at least two virtual graphics processing unit driver modules in the first node according to the preset correspondence; and
feed back the processing results to the target virtual machine to which the target virtual graphics processing unit driver module belongs.

Optionally, after the virtual machine generates the target information including the application request, it may be specifically used for that:
the first processor determines the function type of the target information;
based on the function type of the target information being the first type, the first processor obtains the transmission path information carried in the target information, where the transmission path information at least including the virtual graphics processing unit driver module identifier, the second node identifier, and the target graphics processing unit identifier in the virtual machine; the first processor establishes the transmission path between the virtual graphics processing unit driver module and the target graphics processing unit based on the transmission path information, where the transmission path includes the virtual graphics processing unit driver module in the virtual machine, the first processor, the second processor in the second node, the target service module in the second node, and the target graphics processing unit in the second node;
based on the function type of the target information being the second type, triggering the execution of the first processor based on the target information, determining the corresponding target service module and the transmission path.

Optionally, the first processor may also be used for that:
based on the function type of the target information being the third type, the first processor obtains the transmission path information to be cancelled in the target information, where the transmission path information to be cancelled includes the virtual graphics processing unit driver module identifier corresponding to the transmission path to be cancelled; based on the transmission path information to be cancelled, cancellation information is generated, and the cancellation information is sent to the target service module based on the transmission path to be cancelled, such that the target service module releases the corresponding target graphics processing unit resources.

It should be noted that, for the functional explanation of each component structure in the device for remotely accessing graphics processing units provided in this embodiment, the references may be made to the previous description about the method embodiments, and no further description is given in this embodiment.

In the device for remotely accessing graphics processing units provided in this embodiment, the device may be applied to the first node where the virtual machine and the first processor are deployed. The virtual machine may generate the target information including application request, where the target information satisfies the preset transmission rule between the virtual graphics processing unit driver module and the first processor. The virtual machine may transmit the target information to the first processor. The first processor may determine the transmission path and the target service module in the second node based on the target information, transmit the application request in the target information to the target service module through the second processor of the second node based on the transmission path, and receive the processing results fed back by the second processor through the transmission path. The protocol processing may be accelerated through the hardware DPU and the complex network protocol stack processing process may be offloaded to the hardware level, thereby significantly shortening the processing delay of data at these levels. Compared with the software protocol stack inside the VM, the DPU may have more powerful performance and therefore lower latency.

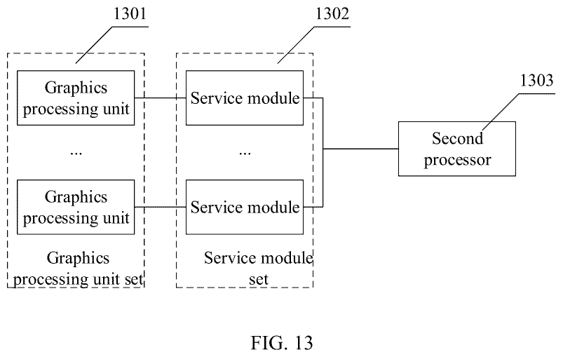

The present disclosure also provides another electronic device for remotely accessing graphics processing units and the electronic device may be applied to the second node. As shown in FIG. 13, in one embodiment, the device includes a graphics processing unit set 1301, a service module set 1302 and a second processor 1303.

The second processor 1301 may be used to receive the application request transmitted by the first processor in the first node; and send the application request to the target service module, where the target service module is correspondingly connected to the target graphics processing unit.

The target service module may be one target service module in the service module set, and may be used to call the target graphics processing unit based on the application request.

The target graphics processing unit may be one graphics processing unit in the graphics processing unit set, and may be used to respond to the application request, obtain the processing results, and feed the processing results back to the second processor.

The second processor may send the processing results to the first processor in the first node.

Optionally, when the target graphics processing unit feeds back the processing result to the second processor,
based on a direct link between the graphics processing unit set and the second processor, the target graphics processing unit may send the processing results to the second processor.

It should be noted that, for the functional explanation of each component structure in the device for remotely accessing graphics processing units provided in this embodiment, the references may be made to the previous description about the method embodiments, and no further description is given in this embodiment.

In the device for remotely accessing graphics processing units provided in this embodiment, the device may be applied to the second node where the graphics processing unit and the second processor are deployed. The second processor may receive the application request transmitted by the first processor in the first node, and send the application request to the target service module corresponding to the target graphics processing unit. The target service module may call the target graphics processing unit based on the application request, such that the target graphics processing unit responds to the application request and obtains the processing results. The target graphics processing unit may feed back the processing results to the second processor in a direct manner, and the second processor may send the processing results to the first processor in the first node. The protocol processing may be accelerated through the hardware DPU and the complex network protocol stack processing process may be offloaded to the hardware level, thereby significantly shortening the processing delay of data at these levels. Compared with the software protocol stack inside the VM, the DPU may have more powerful performance and therefore lower latency.

The present disclosure also provides an electronic device and a readable storage medium.

The electronic device may include one or more memories and one or more processors.

The one or more memories may be configured to store one or more programs; and the one or more processors may be configured to load and execute the one or more programs to implement any method for remotely accessing graphics processing units provided by various embodiments of the present disclosure.

In some embodiments, the electronic device may be applied to the first node and the one or more processors include the first processor. In some other embodiments, the electronic device may be applied to the second node and the one or more processors include the second processor.

For the specific method for remotely accessing graphics processing units implemented by the electronic device, references may be made to the aforementioned method embodiments.

The readable storage medium may be configured to store a computer program thereon. When the computer program is called and executed by a processor, any method for remotely accessing graphics processing units provided by various embodiments of the present disclosure may be implemented.

For the specific method for remotely accessing graphics processing units implemented by the electronic device, references may be made to the aforementioned method embodiments.

In the present disclosure, each embodiment is described in a progressive manner, and each embodiment focuses on the differences from other embodiments. The same or similar parts between the embodiments can be referred to each other. For the device provided in the embodiment, since it corresponds to the method provided in the embodiments, the description is relatively simple, and the relevant parts can be referred to the method embodiments.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the present disclosure. Thus, while the present disclosure has been described in detail with reference to the above described embodiments, the present disclosure is not limited to the above described embodiments, but may be embodied in other equivalent forms without departing from the scope of the present disclosure.

What is claimed is:

1. A method comprising:
generating, by a virtual machine at a first node, target information including an application request, the target information satisfying a preset transmission information rule for transmission between a virtual graphics processing unit driver module of the virtual machine and a first processor at the first node;
determining, by the first processor based on the target information, a target service module at a second node and a transmission path, the target service module being connected to a target graphics processing unit, and the transmission path connecting the virtual graphics processing unit driver, the first processor, a second processor at the second node, and the target service module;
sending, by the first processor, the application request to the target service module based on the transmission path; and
receiving, by the first processor, a processing result fed back by the second processor through the transmission path.

2. The method according to claim 1, wherein generating the target information includes:
intercepting, by the virtual graphics processing unit driver module, the application request output by an application in the virtual machine based on one of at least two interception interfaces of the virtual graphics processing unit driver module that corresponds to the application; and
processing, by the virtual graphics processing unit driver module, the application request according to the preset transmission information rule to obtain the target information.

3. The method according to claim 1, wherein determining the target service module and the transmission path includes:
parsing, by the first processor, the target information to determine the virtual graphics processing unit driver module corresponding to the application request; and
determining, by the first processor, the target service module and the transmission path corresponding to the virtual graphics processing unit driver module based on a preset correspondence relationship, the transmission path including a first transmission module of the first processor and a second transmission module of the second processor, and the first transmission module and the second transmission module being of a same type.

4. The method according to claim 1, further comprising, after receiving the processing result:
parsing, by the first processor, the processing result to determine that the processing result corresponds to the target service module;
determining, by the first processor according to the preset correspondence relationship, the virtual graphics processing unit driver module corresponding to the target service module from at least two candidate virtual graphics processing unit driver modules in the first node; and
feeding, by the first processor, back the processing result to the virtual machine to which the virtual graphics processing unit driver module belongs.

5. The method according to claim 1, further comprising, after generating the target information:
determining, by the first processor, a function type of the target information;
in response to the function type being a first type:
obtaining, by the first processor, transmission path information carried in the target information, the transmission path information at least including an identifier of the virtual graphics processing unit driver module, an identifier of the second node, and an identifier of the target graphics processing unit; and
establishing, by the first processor, the transmission path between the virtual graphics processing unit driver module and the target graphics processing unit based on the transmission path information, the transmission path including the virtual graphics processing unit driver module, the first processor, the second processor, the target service module, and the target graphics processing unit; and
in response to the function type being a second type, triggering execution by the first processor of determining the target service module and the transmission path based on the target information.

6. The method according to claim 5, further comprising:
in response to the function type being a third type:
obtaining, by the first processor, information of a transmission path to be cancelled from the target information, the information of the transmission path to be cancelled including an identifier of a virtual graphics processing unit driver module corresponding to the transmission path to be cancelled;
generating, by the first processor, cancellation information based on the information of the transmission path to be cancelled; and
sending, by the first processor, the cancellation information to a service module at the second node based on the transmission path to be cancelled, to enable the service module to release graphics processing unit resources corresponding to the transmission path to be cancelled.

7. A method comprising:
receiving an application request transmitted by a first processor at a first node, by a second processor at a second node;
sending, by the second processor, the application request to a target service module at the second node, the target service module being connected to a target graphics processing unit;
calling, by the target service module, the target graphics processing unit based on the application request;
responding, by the target graphics processing unit, to the application request to obtain a processing result;
feeding, by the target graphics processing unit, back the processing result to the second processor; and
sending, by the second processor, the processing result to the first processor.

8. The method according to claim 7, wherein feeding back the processing result to the second processor includes:
sending the processing result to the second processor by the target graphics processing unit based on a direct link between a graphics processing unit set including the target graphics processing unit and the second processor.

9. A device comprising:
the second processor;
a service module set including the target service module; and
a graphics processing unit set including the target graphics processing unit;
wherein the second processor, the target service module, and the target graphics processing unit are configured to perform the method of claim 7.

10. The device according to claim 9, wherein the target graphics processing unit is further configured to, when feeding back the processing result to the second processor:
send the processing result to the second processor based on a direct link between the graphics processing unit set and the second processor.

11. A device applied at a first node, comprising:
one or more memories storing one or more programs; and
one or more processors including a first processor and configured to execute the one or more programs to:
generate target information including an application request, the target information satisfying a preset transmission information rule for transmission between a virtual graphics processing unit driver module of a virtual machine at the first node and the first processor;
determine, based on the target information, a target service module at a second node and a transmission path, the target service module being connected to a target graphics processing unit, and the transmission path connecting the virtual graphics processing unit driver, the first processor, a second processor at the second node, and the target service module;
send the application request to the target service module based on the transmission path; and
receive a processing result fed back by the second processor through the transmission path.

12. The device according to claim 11, wherein one or more processors are further configured to execute the one or more programs to, when generating the target information:
intercept the application request output by an application in the virtual machine based on one of at least two interception interfaces of the virtual graphics processing unit driver module that corresponds to the application; and
process the application request according to the preset transmission information rule to obtain the target information.

13. The device according to claim 11, wherein one or more processors are further configured to execute the one or more programs to, when determining the target service module and the transmission path:
parse the target information to determine the virtual graphics processing unit driver module corresponding to the application request; and
determine the target service module and the transmission path corresponding to the virtual graphics processing unit driver module based on a preset correspondence relationship, the transmission path including a first transmission module of the first processor and a second transmission module of the second processor, and the first transmission module and the second transmission module being of a same type.

14. The device according to claim 11, wherein one or more processors are further configured to execute the one or more programs to, after receiving the processing result:
parse the processing result to determine that the processing result corresponds to the target service module;
determine, according to the preset correspondence relationship, the virtual graphics processing unit driver module corresponding to the target service module from at least two candidate virtual graphics processing unit driver modules in the first node; and
feed back the processing result to the virtual machine to which the virtual graphics processing unit driver module belongs.

15. The device according to claim 11, wherein one or more processors are further configured to execute the one or more programs to, after generating the target information:
determine a function type of the target information;
in response to the function type being a first type:
obtain transmission path information carried in the target information, the transmission path information at least including an identifier of the virtual graphics processing unit driver module, an identifier of the second node, and an identifier of the target graphics processing unit; and
establish the transmission path between the virtual graphics processing unit driver module and the target graphics processing unit based on the transmission path information, the transmission path including the virtual graphics processing unit driver module, the first processor, the second processor, the target service module, and the target graphics processing unit; and
in response to the function type being a second type, trigger execution of determining the target service module and the transmission path based on the target information.

16. The device according to claim 15, wherein one or more processors are further configured to execute the one or more programs to, in response to the function type being a third type:
obtain information of a transmission path to be cancelled from the target information, the information of the transmission path to be cancelled including an identifier of a virtual graphics processing unit driver module corresponding to the transmission path to be cancelled;
generate cancellation information based on the information of the transmission path to be cancelled; and
send the cancellation information to a service module at the second node based on the transmission path to be cancelled, to enable the service module to release graphics processing unit resources corresponding to the transmission path to be cancelled.
